(19) United States
(12) Patent Application Publication
(10) Pub. No.: US 2024/0001246 A1
(43) Pub. Date: Jan. 4, 2024

(54) ONLINE GAMING ANTI-CHEAT SYSTEM

(71) Applicant: AT&T Intellectual Property I, L.P., Atlanta, GA (US)

(72) Inventor: Joseph Soryal, Glendale, NY (US)

(21) Appl. No.: 17/854,533

(22) Filed: Jun. 30, 2022

(51) Int. Cl. A63F 13/75

(52) U.S. Cl. CPC A63F 13/75; G06N 20/00

(57) ABSTRACT

A processing system including at least one processor may obtain controller device output data from a user device and may obtain a data feed of a region of a virtual environment associated with a virtual representation of a user of the user device within the virtual environment, the data feed including data identifying at least one action within the virtual environment of the virtual representation of the user. The processing system may then detect a deviation of the at least one action from the controller device output data, wherein the detecting is via at least one machine learning module and generate an alert in response to the detecting of the deviation.

The present disclosure relates generally to online gaming, and more particularly to methods, computer-readable media, and apparatuses for detecting a deviation of at least one action of a virtual representation of a user within a virtual environment from controller device output data.

### BRIEF DESCRIPTION OF THE DRAWINGS

The teaching of the present disclosure can be readily understood by considering the following detailed description in conjunction with the accompanying drawings, in which:

FIG. 1 illustrates an example system related to the present disclosure;

FIG. 2 illustrates a flowchart of an example method for detecting a deviation of at least one action of a virtual representation of a user within a virtual environment from controller device output data; and

FIG. 3 illustrates an example high-level block diagram of a computing device specifically programmed to perform the steps, functions, blocks, and/or operations described herein.

To facilitate understanding, identical reference numerals have been used, where possible, to designate identical elements that are common to the figures.

### DETAILED DESCRIPTION

Examples of the present disclosure describe methods, computer-readable media, and apparatuses for detecting a deviation of at least one action of a virtual representation of a user within a virtual environment from controller device output data. For instance, in one example, a processing system including at least one processor may obtain controller device output data from a user device and may obtain a data feed of a region of a virtual environment associated with a virtual representation of a user of the user device within the virtual environment, the data feed including data identifying at least one action within the virtual environment of the virtual representation of the user. The processing system may then detect a deviation of the at least one action from the controller device output data, wherein the detecting is via at least one machine learning module and generate an alert in response to the detecting of the deviation.

In particular, examples of the present disclosure provide a monitoring system for tracking and alerting of deviations between a user's controller inputs and actions of the user's representation in a virtual environment (e.g., a gaming environment, a virtual reality (VR) environment, which may include an augmented reality (AR) environment, an extended reality or mixed reality (MR) environment, and/or a “metaverse” type environment, etc.). For example, a gaming platform may include multiple participants simultaneously experiencing a shared virtual environment. User devices (e.g., user access devices) may include personal computers, laptop computers, mobile smartphones, gaming consoles, or the like, with associated controller devices, such as a keyboard, mouse, joystick, gaming controller, paddles, etc. User access devices may also include VR headsets, AR headsets, smart glasses or goggles, or the like. A user access device may obtain a data feed of a virtual environment (e.g., a gaming environment) simultaneously with other user access devices, and may render an experience for a user from a given perspective of that particular user within the virtual environment. The virtual environment may include fixed or substantially fixed features, e.g., ground, floors, walls, terrain, etc. and movable and/or temporary features, e.g., representations of other users, virtual objects that are moveable within the space of the virtual environment, and so forth.

Notably, online gaming is pervasive and growing in scale. Many professional games/tournaments include large cash awards or similar prizes, thus incentivizing some participants to cheat. The scale and sophistication of cheating are also increasing. For instance, cheaters may employ malicious software, such as “aimbots,” which may automatically aim and fire in games that include such types of actions, which may help to lock onto a target, which may automatically fire when a target optimally aligned in a sight, which may automatically cause a projectile to reach a target (regardless of aim), and so forth. Other cheating techniques may include actions that are not contemplated as permissible within the game physics, physiology of user representations, mechanical capabilities of a vehicle, etc. For instance, some cheating techniques involve malicious code that enables a user to see through walls, that enables a user representation to be transported through walls or the like, that enables a user representation to exceed what the game authors and/or game code intended to be a maximum speed, maximum jumping height, minimum turning radius, and so forth.

Game designers, gaming platforms (e.g., entities hosting online games, which may be the same or different from the game designers), or other interested parties may employ techniques to detect cheaters, such as scanning Domain Name Service (DNS) traffic to detect user devices accessing uniform resource locators (URLs) associated with cheating, scanning user device memory to detect instances of known malicious code in operation, scanning score leaderboards, user rankings, or the like for patterns indicative of previously mediocre users becoming apparent leaders, advancing to expert level, etc. in a short period of time, and so forth.

However, cheaters may employ more sophisticated malicious programs, which may use artificial intelligence and/or machine learning to mimic human behavior, including human-like weaknesses, “bad luck,” or the like that may circumvent many cheat detection mechanisms. For instance, an aimbot may be configured to miss a certain percentage of shots or to include a configured likelihood of missing a shot. The imperfection of the aimbot may be tuned to help prevent cheating detection mechanisms from flagging a user as cheating. Alternatively, or in addition, a cheat module may be programmed so as to gain just a small advantage to win, while attempting to mimic realistic human behavior to avoid detection. In the long term, and over many games, rounds, etc. a user may increase a winning percentage, a ranking, etc. to gain standing, increase monetary or other rewards, and so forth. The result may be an arms race between cheating AI/ML and cheat detection AI/ML.

Examples of the present disclosure detect cheaters and cheating software by correlating physical actions of a user/player device (movement of a joystick, touching of a screen, moving of a mouse, a keyboard entry or sequence, gesture, facial expression input, etc.) with one or more actions of a virtual representation of a user in a virtual environment (e.g., a gaming environment). In one example, the present disclosure obtains a data feed of a virtual environment, such as from a viewport or perspective of another user, a bird's eye view or the like associated with at least a portion of the virtual environment that includes the virtual representation of the user (e.g., the user's avatar, a virtual vehicle being navigated by the user, etc.).

Examples of the present disclosure verify that each output/signal from a physical controller device (e.g., joystick, keyboard, etc.) corresponds with a correct and/or expected quantified action in the virtual environment. For example, moving a hand-held paddle 10 inches to the left with angle 45 degrees and with speed 20 feet per second may result in one or more physical signals output from the paddle. In correspondence, a virtual representation of a user in the virtual environment (broadly, a “user representation”) may throw a virtual ball across a virtual field with a speed of 100 feet per second, a peak height of 80 feet, an angle of 32 degrees to the left, etc. When the actions of the virtual representation of the user in the virtual environment are in correspondence with the physical outputs of the controller device(s), the present disclosure may thus verify that user actually generated the actions/movements, and not a background application, cheat code, script, or the like that the user may have deployed in order to cheat (or which may operate as a man-in-the-middle application that injects signals or changes signals from the user's gaming device to enhance performance).

In one example, the present disclosure may comprise an client-side anti-cheat application (app) (“ACA”), which may be installed on a user device that is used for access/participating in the virtual environment (e.g., a gaming console, personal computer, mobile computing device, etc.). In addition, a network-based ACA server may be deployed on public or private cloud infrastructure, and/or which may comprise a module of a game server/host, or the like. The user device may have one or more associated controller devices that may be used to navigate and otherwise control a user representation in a virtual environment (e.g., to participate in an online video game). In one example, the ACA server may obtain controller device outputs from the user device (e.g., from the client-side ACA). For instance, the client-side ACA may access and/or obtain a basic input output service (BIOS) output of the user device, may include or utilize a kernel driver to set one or more hooks, may obtain the controller device outputs via a raw input application programming interface (API) of an operating system of the user device (e.g., where the “output” of the controller device is an “input” to the user device), or the like.

In one example, the ACA server may obtain a data feed of the virtual environment as if the ACA server were another player. For instance, a gaming server/host may provide a data feed to each user device in order to enable each user device to render the virtual environment via a respective display from the perspective of an associated user (and/or via speaker(s), headphone(s), etc., for non-visual aspects of the virtual environment). Thus, the gaming server/host may provide a similar data feed to the ACA server. For example, the data feed may be selected for the ACA server by the server(s) hosting the game/virtual environment as if the ACA server were another user/player in the system. The ACA server may then perform a comparison between the actions of the virtual representation of the user in the virtual environment and the physical controller devices output(s).

In one example, the comparison may be via a machine learning (ML)-based module. The ML-based module may include at least one machine learning model (MLM). In one example the ML-based module may also include a comparator function (e.g., depending on the type of MLM that may be used in a particular example). For instance, the present disclosure may collect historical data of controller device outputs and corresponding data feed(s) of the virtual environment, which may be used as training data to train an MLM to learn the correspondence and variation between outputs of a controller device and actions of a user representation in the virtual environment. The training may be via the ACA server, or may be performed via one or more different servers, where the MLM may be installed and operate on the ACA server after the training is completed.

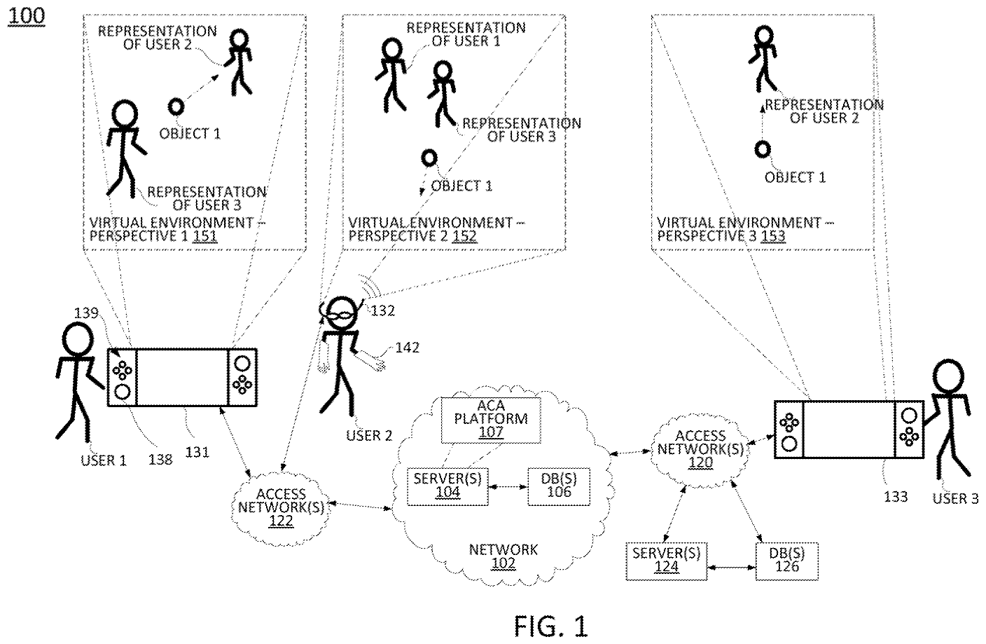

As such, the ACA server may apply the controller device outputs and the data feed of the virtual environment as inputs to the at least one MLM-based module. The output of the MLM-based module may be an indication of whether or not the action(s) of the user representation in the virtual environment are matched to the controller device physical output(s), or a score indicative of the extent to which the action(s) of the user representation in the virtual environment are matched to/correspond to the controller device physical output(s) (and/or the extent to which the action(s) of the user representation in the virtual environment diverge from the controller device physical output(s)). If the ACA server detects a deviation/non-correspondence between the action(s) of the user representation in the virtual environment and the controller device physical output(s), the ACA server may generate an alert. The present disclosure may train and deploy on the ACA server different ML-based modules that may relate to different types of controller devices, different users, and so forth. It should also be noted that the ML-based modules may be game-specific insofar as the in-game physics, physiology of user representations (e.g., maximum speed, maximum jumping height, minimum reload time, etc.), vehicle capabilities (e.g., maximum speed, turning radius, braking/deceleration capability, etc.), and so forth may be different from game to game. In addition, the controller device physical output may correspond to entirely different actions in different virtual environments (e.g., in different video games). These and other aspects of the present disclosure are discussed in greater detail below in connection with the examples of FIGS. 1-3.

To further aid in understanding the present disclosure, FIG. 1 illustrates an example system 100 in which examples of the present disclosure may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., in accordance with 3G, 4G/long term evolution (LTE), 5G, etc.), and the like related to the current disclosure. It should be noted that an IP network is broadly defined as a network that uses Internet Protocol to exchange data packets. Additional example IP networks include Voice over IP (VoIP) networks, Service over IP (SoIP) networks, and the like.

In one example, the system 100 may comprise a network 102, e.g., a telecommunication service provider network, a core network, an enterprise network comprising infrastructure for computing and communications services of a business, an educational institution, a governmental service, or other enterprises. The network 102 may be in communication with one or more access networks 120 and 122, and the Internet (not shown). In one example, network 102 may combine core network components of a cellular network with components of a triple play service network; where triple-play services include telephone services, Internet services and television services to subscribers. For example, network 102 may functionally comprise a fixed mobile convergence (FMC) network, e.g., an IP Multimedia Subsystem (IMS) network. In addition, network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Network 102 may further comprise a broadcast television network, e.g., a traditional cable provider network or an Internet Protocol Television (IPTV) network, as well as an Internet Service Provider (ISP) network. In one example, network 102 may include a plurality of television (TV) servers (e.g., a broadcast server, a cable head-end), a plurality of content servers, an advertising server (AS), an interactive TV/video on demand (VoD) server, and so forth.

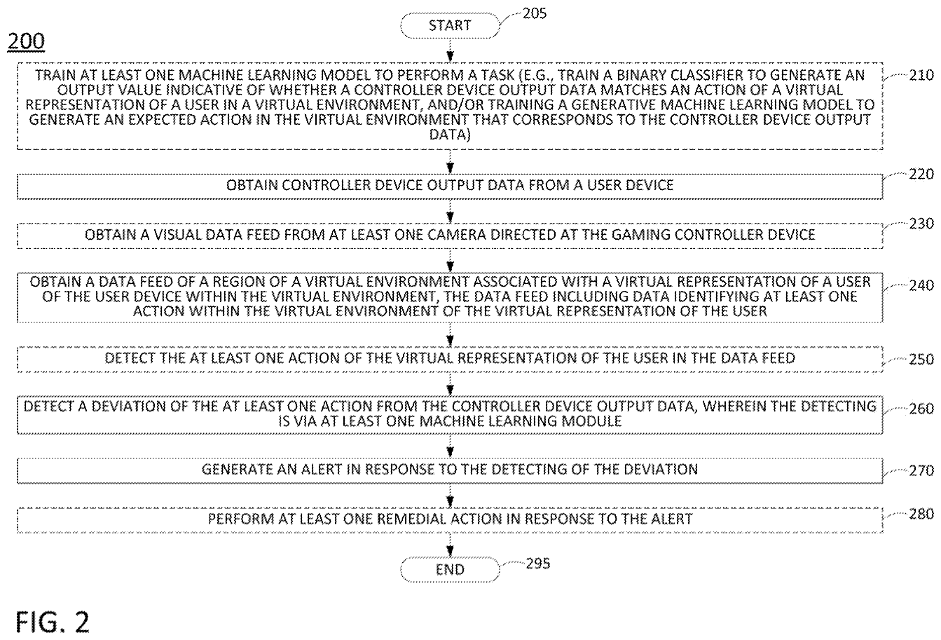

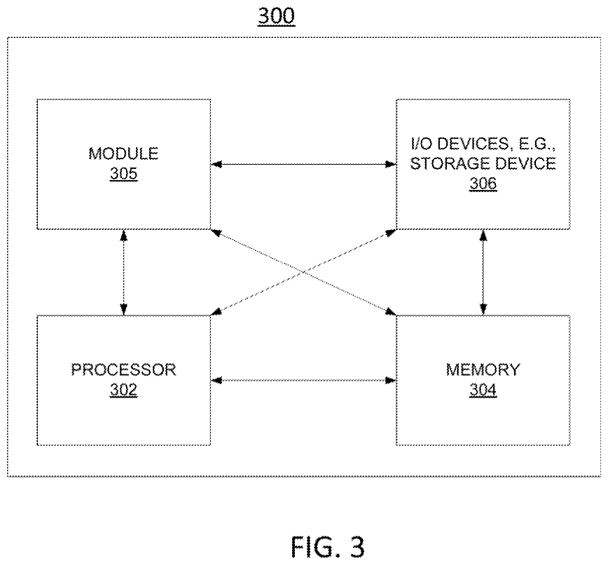

In accordance with the present disclosure, each of the server(s) 104 may comprise a computing system or server, such as computing system 300 depicted in FIG. 3, and may individually or collectively be configured to provide one or more operations or functions for detecting a deviation of at least one action of a virtual representation of a user within a virtual environment from controller device output data, such as illustrated and described in connection with the example method 200 of FIG. 2. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

Thus, although only a single server 104 is illustrated, it should be noted that any number of servers may be deployed, and which may operate in a distributed and/or coordinated manner as a processing system to perform operations for detecting a deviation of at least one action of a virtual representation of a user within a virtual environment from controller device output data, in accordance with the present disclosure. In one example, server(s) 104 may comprise a “virtual environment server,” a game server/host, or the like as described herein. In one example, database(s) (DB(s)) 106 may comprise one or more physical storage devices (e.g., a database server, or servers), to store various types of information in support of systems for detecting a deviation of at least one action of a virtual representation of a user within a virtual environment from controller device output data, in accordance with the present disclosure. For example, DB(s) 106 may store one or more machine learning models (MLMs) for use in detecting deviations/non-correspondence between the action(s) of a user representation in a virtual environment and controller device physical output(s), historical data that may be used to train the one or more MLMs (e.g., controller device output data and corresponding virtual environment data feed segments), user data (including user device data, controller device data (e.g., type, version, model, number, output data schema(s)/formats), etc.), and so forth that may be processed by server(s) 104 in connection with examples of the present disclosure. In addition, DB(s) 106 may also store data characterizing a virtual environment, and which may be used for rendering the virtual environment via user endpoint/access devices (e.g., devices 131-133, or the like). For instance, DB(s) 106 may store data characterizing the terrain of a virtual environment, buildings or other structures in the virtual environment, items or objects in the virtual environment, the user representations that may be present in the virtual environment, rules describing how items or objects in the virtual environment may move, how user representations may move through and interact with objects (e.g., sticks, balls, pucks, discs, or other projectiles, weapons, etc.) or other user representations in the virtual environment, and so forth. For ease of illustration, various additional elements of network 102 are omitted from FIG. 1.

In one example, the access network(s) 122 may be in communication with one or more devices, such as devices 131 and 132. Similarly, access network(s) 120 may be in communication with one or more devices or systems, e.g., device 133, server(s) 124, DB(s) 126, etc. Access networks 120 and 122 may transmit and receive communications between devices 131-133, and server(s) 124 and/or DB(s) 126, server(s) 104 and/or DB(s) 106, other components of network 102, devices reachable via the Internet in general, and so forth.

In one example, each of the devices 131-133 may comprise any single device or combination of devices that may comprise a user endpoint device (or “user device”). For example, devices 131 and 133 may each comprise a portable, handheld gaming console. In addition, device 132 may comprise a wearable computing device (e.g., smart glasses or goggles, an AR and/or VR headset, or the like). Devices 131-133 may also be representative of other types of user devices that may be used to participate in/access a virtual environment (e.g., a video game), such as personal computers, laptop computers, tablet computers, non-handheld gaming consoles, etc. In one example, each of the devices 131-133 may include one or more radio frequency (RF) transceivers for cellular communications and/or for non-cellular wireless communications (e.g., WiFi connections). However, each of the devices 131-133 may alternatively or additionally be configured for wired networking connectivity. In addition, in one example, devices 131-133 may each comprise programs, logic or instructions to perform operations in connection with examples of the present disclosure for detecting a deviation of at least one action of a virtual representation of a user within a virtual environment from controller device output data. For example, devices 131-133 may each comprise a computing system or device, such as computing system 300 depicted in FIG. 3. In one example, devices 131-133 may each include functionality of a client-side anti-cheat application (ACA), as described herein.

Access networks 120 and 122 may transmit and receive communications between such devices/systems, and server(s) 104, other components of network 102, devices reachable via the Internet in general, and so forth. In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3rd party networks, and the like. For example, the operator of network 102 may provide a cable television service, an IPTV service, or any other types of telecommunication service to subscribers via access networks 120 and 122. In one example, the access networks 120 and 122 may comprise different types of access networks, may comprise the same type of access network, or some access networks may be the same type of access network and others may be different types of access networks. In one example, the network 102 may be operated by a telecommunication network service provider. The network 102 and the access networks 120 and 122 may be operated by different service providers, the same service provider or a combination thereof, or may be operated by entities having core businesses that are not related to telecommunications services, e.g., corporate, governmental or educational institution LANs, and the like. In one example, each of access networks 120 and 122 may include at least one access point, such as a cellular base station, non-cellular wireless access point, a digital subscriber line access multiplexer (DSLAM), a cross-connect box, a serving area interface (SAI), a video-ready access device (VRAD), or the like, for communication with devices 131-133 and others.

In an illustrative example, users 1-3 may be engaged within a virtual environment, e.g., hosted by server(s) 104. In other words, users 1-3 may be “immersed” in the virtual environment (e.g., a gaming environment/video game). Accordingly, in one example, server(s) 104 may provide respective data feeds to devices 131-133 for devices 131-133 to generate different renderings of the virtual environment for users 1-3, respectively. For instance, device 131 may render the virtual environment from perspective 1 (151), device 132 may render the virtual environment from perspective 2 (152), and device 133 may render the virtual environment from perspective 3 (153). Each of the users 1-3 may have a different location and vantage/view within the virtual environment. In addition, each user may appear to others as a user representation, or “virtual representation of a user” (e.g., an avatar such as an anthropomorphized animal or object, a cartoonified representation of the user, such as bitmoji or the like, a different character selected by the user, an accurate three dimensional rendering/model of the user, or the like, a virtual vehicle being navigated by the user, and so forth) within the virtual environment. It should be noted that a “user representation” may also include multiple avatars, characters, vehicles, or the like. For instance, a user may control a main avatar and a companion (e.g., a clone, a decoy character, a shadow character, etc.). In one example, the companion may operate under automatic programming/control by default (e.g., per a game designer configuration). However, the user may toggle to manually control the companion via a respective user device and/or associated controller device. Similarly, a user may control a fleet of vehicles and may generate commands to collectively direct all or part of the fleet, but may alternatively or additionally toggle to one or more individual vehicles to provide individual control. As such, the “user representation” may comprise the fleet.

For illustrative purposes, the example of FIG. 1 depicts essentially humanoid user representations. Thus, for instance, user 1 may see a representation of user 3 on the left and a representation of user 2 off in the distance from perspective 1 (151) rendered via device 131. Similarly, user 3 may see a representation of user 2 in the distance. The representation of user 1 is behind the representation of user 2 and is not visible at the instant in time that is illustrated in perspective 3 (153) in FIG. 1. On the other hand, user 2 may see representations of users 1 and 3 in the distance via perspective 2. For instance, users 1-3 may be engaged in a game of virtual dodgeball, where users 1 and 3 are on the same team, and user 2 is on the other team. In the present example, the virtual environment may be experienced by users 1-3 from a first-person perspective. However, it should be noted that in other examples, the virtual environment may be experienced in a different manner, such as from a perspective above, below, and/or behind a user representation of a respective user 1-3 (e.g., a “bird's eye view” or the like).

For illustrative purposes, an object 1 is also shown in FIG. 1, e.g., a virtual object that may be moved and interacted with by the representations of users 1-3 within the virtual environment via use of respective controller devices (e.g., controller devices 138 and 139 of device 131, and similarly for device 133). For instance, object 1 may be a virtual ball for a game of virtual dodgeball. In one example, interaction with object 1 may also be simulated in the physical world by force feedback gloves 142, e.g., via instructions from server(s) 104. For instance, force feedback gloves 142 may include a gyroscope, a compass, one or more accelerometers, and so forth. Force feedback gloves 142 may also include a plurality of actuators which may be controllable to provide positive force and/or movement of various portions of the hands of user 2 (e.g., electromechanical actuators or motors, electro-hydraulic actuators, electro-pneumatic actuators, etc.). In one example, force feedback gloves 142 may also include transceivers for wireless communications, wired communication, etc.

In accordance with the present disclosure, server(s) 104 may include an anti-cheat application (ACA) platform 107. For instance, a first one or more of server(s) 104 may host the virtual environment, while a second one or more of server(s) 104 may host the ACA platform 107. In other words, the ACA platform 107 may be a separate and distinct platform from the virtual environment server(s). In another example, the ACA platform 107 may comprise a separate process (or processes) on a shared hardware platform with the virtual environment host (e.g., the same one or more of server(s) 104). In one example, ACA platform 107 may be user-specific. In other words, there may be multiple ACA platforms hosted by server(s) 104, e.g., one for each user, or one for each user that opts-in to anti-cheat verification in accordance with the present disclosure. Alternatively, or in addition, ACA platform 107 may comprise different modules for different users (e.g., different ML-based modules for detecting deviations/non-correspondence between the action(s) of a user representation in the virtual environment and respective controller device physical output(s), and/or different ML-based modules for controller devices of different types, versions, model numbers, etc., and so forth).

For illustrative purposes, ACA platform 107 may be associated with user 1 (e.g., dedicated to user 1, or at least including one or more modules that is/are tailored to user 1 and/or to one or more of the controller devices 138 or 139 associated with device 131). Accordingly, in one example, ACA platform 107 may obtain a data feed pertaining to a region of the virtual environment experienced by user 1 (e.g., the region of the virtual environment in which the representation of user 1 is present). It should be noted that the virtual environment may represent a substantial volume of virtual space. As such, for each of the users 1-3 (and others), the server(s) 104 hosting the virtual environment may provide respective data feeds to devices 131-133 for rendering the virtual environment from perspectives 1-3, respectively. In other words, each data feed may include less than all of the data representing the state of the virtual environment at a given point in time, or times. For example, each of the devices 131-133 may be provided with just enough data to render a respective one of the perspectives 1-3. Any visual or other data beyond the perspective may be omitted from the respective data feed. However, it should be noted that in one example, data for rendering aspects of the virtual environment that are just beyond the view/perspective may also be included in the data feed. For instance, if user 1 (e.g., the representation of user 1) is moving very quickly in the virtual environment or changes the direction of view very quickly, the data feed may include additional data to enable the device 131 to quickly render from the changed perspective. Thus, some data of the feed may go unused for rendering, but may be available if needed depending upon the actions of user 1.

Similarly, ACA platform 107 may obtain a data feed for the region of the virtual environment (e.g., representing less than all of the virtual environment). In one example, the data feed may be selected for ACA platform 107 by the server(s) 104 hosting the virtual environment as if the ACA platform 107 were another user in the system. For instance, in one example, a view/perspective of ACA platform 107 may be assumed to be a certain distance in front of and facing the representation of user 1. In another example, the view/perspective of ACA platform 107 may be assumed to be facing the representation of user 1, but in front of and above the representation of user 1 within a space of the virtual environment (e.g., a “bird's-eye view” facing the representation of user 1). In one example, the view/perspective of ACA platform 107 may change in relation to a location of the representation of user 1 in the virtual environment. For instance, this may help to enable the ACA platform 107 to view items/objects and/or user representations from one perspective that may be occluded or hidden from other perspectives.

In one example, a data feed may comprise a volumetric video, a 360 degree video, or the like. In one example, a data feed may comprise visual data for a respective viewport (e.g., for device 131, a view from a current location (or one or more predicted locations)) within the virtual environment and in current direction (or one or more predicted directions of view; for the ACA platform 107, a view toward the representation of user 1, and at least including the representation of user 1). In one example, the data feed for user 1 may be generated by server(s) 104 by blending data regarding fixed or relatively fixed features of the virtual environment (e.g., terrain, buildings, etc.), with data regarding moveable objects (e.g., object 1) and user representations (e.g., representations of users 2 and 3).

Alternatively, or in addition, data regarding fixed or relatively fixed features of the virtual environment may initially be provided to device 131 and to ACA platform 107. Dynamic features may then be described to device 131 and to ACA platform 107 via subsequent data of the respective data feeds (e.g., changes in the perspective 1 of user 1, changes in the location of the representation of user 1, and hence corresponding changes in the view/perspective of ACA platform 107, etc.). In any case, ACA platform 107 may thus obtain a data feed that provides a view of the representation of user 1 within the virtual environment. It should also be noted that although the example of FIG. 1 is illustrated with respect to a 3D virtual environment, the present disclosure is not so limited. For instance, in other examples, the virtual environment may comprise a 2D environment (e.g., a horizontal scrolling 2D game, a bird's eye view 2D game, etc.).

When user 1 is engaged in the virtual environment, ACA platform 107 may monitor, on an ongoing basis, the region of the virtual environment in which the representation of user 1 is engaged in order to detect deviations of actions of the representation of user 1 from controller device output data (e.g., the output(s) of controller device 138 and/or controller device 139). For instance, controller device 138 may comprise a joystick, while controller device 139 may comprise an array of buttons/keys. In one example, ACA platform 107 may obtain controller device outputs from device 131 (e.g., via a client-side ACA). For instance, in one example, the client-side ACA may access and/or obtain a BIOS output of the user device. In another example, the client-side ACA may include or utilize a kernel driver to set one or more hooks, may obtain the controller device outputs via a raw input application programming interface (API) of an operating system of the user device (e.g., where the “output” of the controller device(s) 138 and/or 139 is an “input” to the user device 131), or the like. It should be noted that although controller devices 138 and 139 are illustrated as being integrated with device 131, in other, further, and different examples, controller devices may be pluggable peripheral input devices, may communicate wirelessly with a respective user device, and so forth.

As noted above, ACA platform 107 may also obtain a data feed that provides a view of the representation of user 1 within the virtual environment (e.g., from server(s) 104 hosting the virtual environment, such as a video game host server/platform). The ACA platform 107 may then perform a comparison between the actions of the user representation 1 in the virtual environment and the physical controller devices output(s). For instance, ACA platform 107 may implement and/or have installed thereon a machine learning (ML)-based module that includes at least one machine learning model (MLM). In one example the ML-based module may also include a comparator function (e.g., depending on the type of MLM that may be used in a particular example). For example, DB(s) 106 may store models and/or modules for detecting variations between physical outputs of a controller device and actions of a user representation in the virtual environment that may be used by ACA platform 107. To illustrate, server(s) 104 and/or ACA platform 107 may generate (e.g., train) and store models that may be applied by ACA platform 107 (and/or other ACA platforms). For instance, each model and/or module may be specific to a user/user representation, a type of user representation, a controller device type, make, model, etc., and/or a particular virtual environment, and so forth.

It should be noted that as referred to herein, a machine learning model (MLM) (or machine learning-based model) may comprise a machine learning algorithm (MLA) that has been “trained” or configured in accordance with input training data to perform a particular service, e.g., in one example, to detect and/or quantify variations between physical outputs of a controller device and actions of a user representation in a virtual environment, in another example, to provide a generative output comprising a predicted action of a user representation in a virtual environment based on physical outputs of a controller device.

In various examples, a MLA, or an MLM trained via the MLA, may comprise, for example, a deep learning neural network, or deep neural network (DNN), a generative adversarial network (GAN), a support vector machine (SVM), e.g., a binary, non-binary, or multi-class classifier, a linear or non-linear classifier, and so forth. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth. It should be noted that various other types of MLAs and/or MLMs may be implemented in examples of the present disclosure, such as k-means clustering and/or k-nearest neighbor (KNN) predictive models, support vector machine (SVM)-based classifiers, e.g., a binary classifier and/or a linear binary classifier, a multi-class classifier, a kernel-based SVM, etc., a distance-based classifier, e.g., a Euclidean distance-based classifier, or the like, and so on.

In one example, a machine learning module of the present disclosure may comprise a binary classifier with inputs comprising: (1) output data of one or more controller devices and (2) a data feed of the virtual environment. The output of the binary classifier may comprise an indicator of whether the output data of the controller device(s) and the data feed match (or whether the output data of the controller device(s) is legitimate). To train such a model, positive examples can include controller device output data and corresponding portions of a data feed of the virtual environment for trusted test users operating without cheats, and negative examples may be pairs of the same types of input data from users deploying known cheating mechanisms in a laboratory setting. In one example, a binary classifier, such as SVM, may provide a likelihood or confidence score indicative of a likelihood of cheating/not-cheating. For instance, the input data (e.g., data values from (1) output data of one or more controller devices and (2) a data feed of the virtual environment) may comprise a point in a hyper-dimensional space (e.g., a “feature space”) and the distance of such point to a separation hyperplane may comprise a value indicative of the confidence or likelihood of correct classification (e.g., of cheating or not cheating). In such an example, a “machine learning module” may thus comprise at least one machine learning model.

In another example, a machine learning module of the present disclosure may comprise a generative MLM (or “generator model”) with a supplemental comparator (e.g., a similarity or difference function). For instance, the generative MLM may comprise a transformer based encoder/decoder model, a generative adversarial network (GAN), or the like with input(s) comprising output data of one or more controller devices. The output of the generative MLM may comprise a predicted outcome in virtual environment (e.g., an action or change in the virtual environment). For instance, the output may comprise data values representing a state of at least a portion of the virtual environment (or a sequence of states (e.g., frames) of at least a portion of the virtual environment) containing one or more predicted actions and/or an outcome of such predicted action(s).

In one example, the generative MLM outputs may be values for features that relate to the user representation. For instance, if a game program is configured to provide other users with a vector of data describing the user representation and/or its movements, this data can be situated within such a generative space (e.g., instead of generating an actual frame data for full rendering of the virtual environment at a predicted time or sequence of time (e.g., a sequence of frames), the generative MLM may simply generate an expected vector based on the inputs to the generative MLM). The output of the generative MLM may then be fed to a comparator to calculate a similarity (and/or difference) metric between the output of the generative MLM and the actual data feed of the virtual environment. For instance, the comparator may calculate a “distance” between the output of the generative MLM and the actual data feed of the virtual environment. The distance, may comprise, for example, a cosine distance or cosine similarity (based on images, frames (e.g., sequence of images), or the like, or on other data vectors), a structural similarity index metric (SSIM), etc.

It should be noted that in either of the foregoing examples, the output of the machine learning-based module may output a distance metric or other values that may represent the likelihood that at least one action of the user representation is (or is not) a result of the controller device output(s) (with some error based upon the accuracy of the generative MLM output or some error possible from a distance-based classifier, e.g., differences or lack thereof can be random or due to other factors). In other words, the output may be a score indicative of the extent to which the action(s) of the user representation in the virtual environment are matched to or correspond to the controller device physical output(s) (and/or the extent to which the action(s) of the user representation in the virtual environment diverge from the controller device physical output(s)).

If the ACA platform 107 detects a deviation/non-correspondence between the action(s) of the user representation in the virtual environment and the controller device physical output(s), the ACA platform 107 may generate an alert and transmit the alert to the server(s) 104 hosting the virtual environment (e.g., the video game host server(s)). The alert(s) may indicate the user/user representation for which cheating is detected, the confidence/likelihood score or the like, and so forth. In one example, confidence/likelihood score (e.g., a distance metric) may be averaged over time, and the average compared to a threshold for alerting. Similarly, in one example in which the machine learning-based module provides a binary output (e.g., cheating/no-cheating), the ACA platform 107 may collect the outputs over time for application of an alerting threshold. For instance, if N percent of the outputs of the machine learning-based module over a rolling time window comprise a value indicative of “cheating,” the alert may be issued. In other words, an alert threshold may be N percent, e.g., 2 percent, 8 percent, 10 percent, etc. In this regard, it should be noted that the threshold may be different in different scenarios in response to the changing types of cheating mechanisms. For instance, some aimbots may only be used for one in ten shots by a cheating user to attempt to avoid detection while gaining a small advantage in high-stakes gameplay.

In addition, in some examples, the ACA platform 107 may be configured to account for normal and expected performance degradation over the course of a game due to user/player being tired, but also to account for emotional spikes when the user/player finds strength for a final effort, one last shot, etc. In one example, the machine learning-based module (e.g., the MLM(s) thereof) may be trained to distinguish actual cheating patterns and differentiate them from genuine energy spikes. Similarly, the ACA platform 107 may be configured to observe and detect injuries during a game, and account for the impact of these injuries on the performance during the rest of the game. For instance, if a user appears to recover very fast from a muscle strain during the game (e.g., as indicated by a resurgence in performance level, such as greatly improved speed, accuracy, etc.), this may be indicative of a cheating mechanism in effect.

It should also be noted that in one example, the ACA platform 107 may not scan the entirety of a game session, but may instead monitor for certain events, and then apply the above-described operations of ACA platform 107 in connection with such events. For instance, if the user representation of user 1 is simply walking around a virtual environment and not interacting with other user representations, objects, etc., the ACA platform 107 may remain in a standby mode. However, when an action involves another user representation or object, when an action results in a reward to user 1 (and/or a loss to another user in the stakes of the game), etc., then ACA platform 107 may apply controller device output(s) and a data feed of the virtual environment to the machine learning-based module to determine whether and/or to what extent the output data of the controller device(s) 138 and/or 139 and the data feed match (and/or do not match). For instance, the ACA platform 107 may obtain the output data of the controller device(s) 138 and/or 139 and the data feed of the virtual environment on an ongoing basis. The ACA platform 107 may then apply one or more event detection models to the data feed of the virtual environment to determine that an event of a defined event type has occurred. If no event of one or more defined event types is detected, the ACA platform 107 may discard, overwrite, or otherwise allow the output data of the controller device(s) 138 and/or 139 and the data feed of the virtual environment to lapse. However, when an event is detected, the output data of the controller device(s) 138 and/or 139 and the data feed of the virtual environment already possessed by the ACA platform 107 may then be fed as inputs to the machine learning-based detection module.

The event detection model(s) may comprise one or more additional MLMs trained to detect such events from the visual and/or other data of the data feed of the virtual environment. For example, in order to detect an event (e.g., semantic content) of “thrown ball” in image data of the data feed of the virtual environment, ACA platform 107 may deploy a detection model (e.g., stored in DB(s) 106). This may include one or more images and/or frame sequences of thrown balls in the virtual environment (e.g., from different angles, in different scenarios, different types of firearms, etc.), and may alternatively or additionally include feature set(s) derived from one or more images and/or frame sequences of thrown balls, respectively. For instance, DB(s) 106 may store a respective scale-invariant feature transform (SIFT) model, or a similar reduced feature set derived from image(s) of thrown balls, which may be used for detecting additional instances of thrown balls in image data via feature matching. Thus, in one example, a feature matching detection algorithm/model stored in DB(s) 106 may be based upon SIFT features. However, in other examples, different feature matching detection models/algorithms may be used, such as a Speeded Up Robust Features (SURF)-based algorithm, a cosine-matrix distance-based detector, a Laplacian-based detector, a Hessian matrix-based detector, a fast Hessian detector, etc.

The visual features used for detection of “thrown ball” or other events/semantic content (such as “dodge and roll,” “barrel roll,” “spin jump,” etc.) may include low-level invariant image data, such as colors (e.g., RGB (red-green-blue) or CYM (cyan-yellow-magenta) raw data (luminance values) from a CCD/photo-sensor array), shapes, color moments, color histograms, edge distribution histograms, etc. Visual features may also relate to movement in a sequence of image data and may include changes within images and between images in a sequence (e.g., video frames or a sequence of still image shots), such as color histogram differences or a change in color distribution, edge change ratios, standard deviation of pixel intensities, contrast, average brightness, and the like.

In one example, ACA platform 107 may perform an image salience detection process, e.g., applying an image salience model and then performing an image recognition algorithm over the “salient” portion of the image(s) or other image data/visual information. Thus, in one example, visual features may also include a length to width ratio of an object, a velocity of an object estimated from a sequence of images (e.g., video frames), and so forth. Similarly, in one example, ACA platform 107 may apply an object/item detection and/or edge detection algorithm to identify possible unique items in image or other visual data (e.g., without particular knowledge of the type of item; for instance, the object/edge detection may identify an object in the shape of a user representation in a video frame, without understanding that the object/item is a user representation). In this case, visual features may also include the object/item shape, dimensions, and so forth. In such an example, object/item recognition may then proceed as described above (e.g., with respect to the “salient” portions of the image(s) and/or video(s)).

It should be noted that in one example, the data feed provided to ACA platform 107 may include explicit/direct indicators of event, such as thrown ball, a particular movement or action of a user representation of user 1, etc. For instance, as noted above, data regarding fixed or relatively fixed features of the virtual environment may initially be provided to devices 131-133 and to ACA platform 107. Dynamic features may then be described to devices 131-133 and to ACA platform 107 via subsequent data of the respective data feeds. Accordingly, in one example, depending upon the game programming design, the dynamic features may include a starting position of a user representation, an ending position, and an action to be performed (e.g., a barrel roll). Thus, for example, if the representation of user 1 is to perform a barrel roll, the data feeds for users 2 and 3, and for the ACA platform 107 may, in one example, include such a specific indication. It is then left to the devices 132 and 133 to render the action via the respective devices. However, the example(s) described above involving event detection model(s) may be used where the ACA platform 107 is not directly associated with the gaming platform. For instance, the ACA platform 107 may be offered by a different entity than the gaming host/platform. In addition, in one example, the ACA platform 107 may be applied for different virtual environments, e.g., as a third-party service. Thus, these and other modifications are all contemplated within the scope of the present disclosure.

In one example, server(s) 104 hosting the virtual environment may perform one or more remedial actions in response to receiving an alert, such as warning user 1 via a message for presentation on device 131 or a message to an email address, phone number, or the like associated with user 1. For instance, users may be given two strikes, three strikes, etc. before escalating to a more severe penalty. In this regard, the remedial action may alternatively or additionally comprise causing user 1 to forfeit a current round of a game, to forfeit recent game winnings, game finds, etc., blocking/banning an account of user 1 from further play of the game (e.g., for a certain time period, such as one week, two weeks, one month, etc., or indefinitely), and so forth. In one example, the remedial action may extend to all IP addresses and/or user device hardware identifiers known to be associated with user 1, other accounts associated with user 1 (e.g., alias accounts, etc.), and so on. In one example, the remedial action may be dependent upon a confidence/likelihood score, a number of prior warnings/alerts, and so on.

It should be noted that the foregoing and FIG. 1 illustrate just several representative examples, and that other, further, and different examples may readily be provided in accordance with the present disclosure. In addition, although the foregoing example(s) is/are described and illustrated in connection with a single virtual environment, it should again be noted that in one example, (potential) cheating users may be tracked across several virtual environments, e.g., by the same or different ACA platform 107. In one example, ACA platform 107 may adjust the use of various machine-learning based modules (and the MLMs and/or comparators thereof) accordingly (e.g., to use the virtual environment-specific detection models that are tuned to the characteristics of the virtual environment).

In one example, the ACA platform 107 may be provided with data feeds representing several views of the representation of user 1, such as akin to a computed tomography (CT) scan or obtaining a set of magnetic resonance imaging (MRI) images. For instance, the ACA platform 107 may apply MLM(s) of the machine learning-based module(s) to visual or other data from the data feed from several perspectives. It should also be noted that the example of FIG. 1 illustrates just several examples of user devices that may be used to interact with/experience a virtual environment. As such, it should be noted that in other, further, and different examples, users may alternatively or additionally interact with and experience a virtual environment using network-connected cycles, shoes, and or treadmills, a network of body worn sensors to detect movements of limbs, and so forth, which may translate such movements into actions of a corresponding user representation in the virtual environment.

It should also be noted that the system 100 has been simplified. In other words, the system 100 may be implemented in a different form than that illustrated in FIG. 1. For example, the system 100 may be expanded to include additional networks and additional network elements (not shown) such as wireless transceivers and/or base stations, border elements, routers, switches, policy servers, security devices, gateways, a network operations center (NOC), a content distribution network (CDN) and the like, without altering the scope of the present disclosure. In addition, system 100 may be altered to omit various elements, substitute elements for devices that perform the same or similar functions and/or combine elements that are illustrated as separate devices.

As just one example, one or more operations described above with respect to server(s) 104 and/or ACA platform 107 may alternatively or additionally be performed by server(s) 124, and vice versa. In this regard, DB(s) 126 may store the same or similar information as DB(s) 106 as described above. Similarly, although the foregoing is described in connection with ACA platform 107 being part of server(s) 104, in another example, ACA platform 107 may instead be installed as a standalone module within one of the devices 131-133.

In addition, although a single server 104 and a single server 124 are illustrated in the example of FIG. 1, in other, further, and different examples, the same or similar functions may be distributed among multiple other devices and/or systems within the network 102, access network(s) 120 or 122, and/or the system 100 in general that may collectively provide various services in connection with examples of the present disclosure for detecting a deviation of at least one action of a virtual representation of a user within a virtual environment from controller device output data. Additionally, devices that are illustrated and/or described as using one form of communication (such as a cellular or non-cellular wireless communications, wired communications, etc.) may alternatively or additionally utilize one or more other forms of communication. Thus, these and other modifications are all contemplated within the scope of the present disclosure.

FIG. 2 illustrates a flowchart of an example method 200 for detecting a deviation of at least one action of a virtual representation of a user within a virtual environment from controller device output data. In one example, steps, functions and/or operations of the method 200 may be performed by a device or apparatus as illustrated in FIG. 1, e.g., by server(s) 104 and/or servers(s) 124, such as an ACA platform 107, or any one or more components thereof, or by server(s) 104 (e.g., ACA platform 107) and/or servers(s) 124, and/or any one or more components thereof in conjunction with one or more other components of the system 100, such as devices 131-133, and so forth. In one example, the steps, functions, or operations of method 200 may be performed by a computing device or processing system, such as computing system 300 and/or hardware processor element 302 as described in connection with FIG. 3 below. For instance, the computing system 300 may represent any one or more components of the system 100 that is/are configured to perform the steps, functions and/or operations of the method 200. Similarly, in one example, the steps, functions, or operations of the method 200 may be performed by a processing system comprising one or more computing devices collectively configured to perform various steps, functions, and/or operations of the method 200. For instance, multiple instances of the computing system 300 may collectively function as a processing system. For illustrative purposes, the method 200 is described in greater detail below in connection with an example performed by a processing system. The method 200 begins in step 205 and may proceeds to optional step 210 or to step 220.

At optional step 210, the processing system may train at least one machine learning model to perform a task in accordance with the present disclosure. For instance, in one example, optional step 210 may comprise training a binary classifier to generate an output value indicative of whether a controller device output data matches an action of a virtual representation of a user in a virtual environment. As noted above, the training data may comprise historical data of controller device physical outputs and corresponding data feed(s) of the virtual environment (with labels indicative of cheating or not cheating). In another example, optional step 210 may comprise training a generative MLM to generate expected action in the virtual environment that corresponds to controller device output data (e.g., for each instance of controller device output data, to generate a respective corresponding expected action). Similar to the previous example, the training data may comprise historical data of controller device physical outputs and corresponding data feed(s) of the virtual environment. In one example, the present disclosure may deploy multiple MLMs. In such case, optional step 210 may comprise training both a binary classifier and a generative MLM. Alternatively, or in addition, the multiple MLMs may be trained for different controller device types, different virtual environments, different users, and so forth.

At step 220, the processing system obtains controller device output data from a user device. For instance, the controller device output data may be obtained from a gaming controller device (e.g., a keyboard, mouse, game pad, joystick, paddles, touch pad, force feedback gloves, or the like). In other words, the controller device may be a gaming controller device that is attached to and/or in communication with the user device (e.g., via a wired and/or wireless connection, such as Bluetooth, infrared and/or another proprietary wireless protocol, etc.) In one example, the controller device output data may be obtained via a kernel driver of the user device. In another example, the controller device output data may be obtained via a hook-based monitoring. In still another example, the controller device output data may be obtained via a raw input API of an operating system of the user device (e.g., a Windows Application Programming Interface (WinAPI)-based monitoring or the like). In one example, the user device may collect the controller device output data and forward the controller device output data to the processing system (e.g., a network-based ACA platform) via a client-side anti-cheat application (“ACA”).

At optional step 230, the processing system may obtain a visual data feed from at least one camera directed at the controller device. For instance, the user may voluntarily consent and may set up a camera directed at the controller device (e.g., to “watch” the user's hands interact with a keyboard, joystick, mouse, etc.). In addition, the camera may also be configured to stream the visual data feed to the processing system (e.g., independently and/or via the user device (e.g., via the client-side ACA thereof). In one example, the visual data feed may be used as a secondary and/or supplemental verification input as described below.

At step 240, the processing system obtains a data feed of a region of a virtual environment associated with a virtual representation of a user of the user device within the virtual environment, the data feed including data identifying at least one action within the virtual environment of the virtual representation of the user. For instance, as noted above, the processing system may comprise an ACA platform and/or a module thereof that is assigned to the user, where the representation of the user may currently be located within the region of the virtual environment. In another example, the processing system may comprise a processing system of a server hosting the virtual environment and the method 200 may be performed via at least one first process that is distinct from at least one second process that is for hosting the virtual environment. In such case, the at least one second process may provide the data feed of the region of the virtual environment. In still another example, the processing system may be a processing system of a first server and the virtual environment may be hosted via at least a second server, where the at least the second server provides the data feed of the region of the virtual environment.

The representation of the user may comprise an avatar, such as anthropomorphized animal or object, a cartoonified representation of the user, such as bitmoji or the like, a different character selected by the user, a virtual vehicle (e.g., for a game in which the user is driving, flying, etc.), and so forth. It should be noted that the server(s) hosting the virtual environment may provide the structure of the virtual environment via the data feed (e.g., permanent or semi-permanent features such as ground/terrain, buildings, trees, etc.), as well as transitional features of the virtual environment (e.g., representations of users, their movements, sounds, interactions with each other, etc., moveable virtual items/objects, and so forth). In one example, the processing system may receive a data feed that includes visual data from one or more perspectives facing the representation of the user, e.g., a head-on view, a birds-eye view, etc. Thus, the data feed obtained at step 240 may include visual data from one or more of such perspectives. It should be noted that the data feed may include multiple communications from the server(s) hosting the virtual environment. In one example, the data feed may provide initial data to render the fixed or relatively fixed features in the region of the virtual environment, while subsequent portions of the data feed may include additional data for rendering transitional features. It should also be noted that the term “data feed” may include visual and/or audio data (and may further include other data, such as status information of the user representation (e.g., health, ammunition, etc.) and/or other user representations, etc.) received on an ongoing basis over a period of time, e.g., for the duration of a game.

In still another example, the virtual environment may not be centrally hosted by any server, or servers. Instead, the virtual environment may be rendered individually by different endpoint devices, where the endpoint devices communicate with each other as peers to provide updated information of different user representations and/or items being manipulated by such user representations (e.g., location, pose, trajectory, etc.). In such case, the processing system may participate as a peer in the system in order to provide cheating detection/non-cheating verification on behalf of one or more users, and the data feed may be obtained from (e.g., aggregated based on data from) the user device and one or more other user devices participating in the virtual environment (e.g., a video game).

In one example, the data feed can be a visual feed that would be provided by a gaming host server as if the processing system were another user. In one example, the data fed may include visual and other data (e.g., depending on the particular game, it could be velocity and acceleration data of other user representations, trajectories, velocity, acceleration, etc. of projectiles, or the like, and so forth). In one example, the at least one action may comprise an emitting of a virtual projectile within the virtual environment associated with the virtual representation of the user (e.g., the user representation throwing a virtual ball, shooting a virtual arrow, laser beam, etc.), and so forth. Alternatively, or in addition, the at least one action may comprise a movement within the virtual environment of the virtual representation of the user (e.g., running, jumping, dodging, catching, rolling, swinging, etc.). In general, movement can be a change of position in the space of the virtual environment, a change in orientation, movement of appendages, changes in pose or posture, a sequence of movement of appendages, pose, posture, etc., throwing, aiming, catching, and so forth.

At optional step 250, the processing system may detect the at least one action of the virtual representation of the user in the data feed, e.g., via a detection model or via direct indication in the data feed, such as described above.

At step 260, the processing system detects a deviation of the at least one action from the controller device output data, wherein the detecting is via at least one machine learning module. In one example, step 260 (and subsequent steps) may be performed in response to the detecting of the at least one action of the virtual representation of the user in the data feed. In one example, step 260 may comprise a comparison between the actions of the user representation in the virtual environment and the controller devices output data. For instance, the processing system may implement and/or have installed thereon a machine learning (ML)-based module that includes at least one MLM. In one example the ML-based module may also include a comparator function (e.g., depending on the type of MLM that may be used in a particular example).

In one example, a machine learning module of the present disclosure may comprise a binary classifier with inputs comprising: (1) the controller device output data and (2) the data feed of the virtual environment. The output of the binary classifier may comprise an indicator of whether the output data of the controller device(s) and the data feed match (or whether the output data of the controller device(s) is legitimate). In one example, a binary classifier may provide a likelihood or confidence score indicative of a likelihood of cheating/not-cheating. For instance, the input data (e.g., data values from (1) the controller device output data and (2) the data feed of the virtual environment) may comprise a point in a hyper-dimensional space (e.g., a “feature space”) and the distance of such point to a separation hyperplane may comprise a value indicative of the confidence or likelihood of correct classification (e.g., of cheating or not cheating).

In another example, a machine learning module of the present disclosure may comprise a generative MLM (or “generator model”) with a supplemental comparator (e.g., a similarity or difference function). For instance, the generative MLM may comprise a transformer based encoder/decoder model, a generative adversarial network (GAN), or the like with input(s) comprising output data of one or more controller devices. The output of the generative MLM may comprise a predicted outcome in virtual environment (e.g., an action or change in the virtual environment). For instance, the output may comprise data values representing a state of at least a portion of the virtual environment (or a sequence of states (e.g., frames) of at least a portion of the virtual environment) containing one or more predicted actions and/or an outcome of such predicted action(s).

In one example, the generative MLM outputs may be values for features that relate to the virtual representation of the user in the virtual environment. For instance, if a game program is configured to provide other users with a vector of data describing the user representation and/or its movements, this data can be the generative space (e.g., instead of generating an actual frame data for full rendering of the virtual environment at a predicted time or sequence of time (e.g., a sequence of frames), the generative MLM may simply generate an expected vector based on the inputs to the generative MLM). The output of the generative MLM may then be fed to a comparator to calculate a similarly (and/or difference) metric between the output of the generative MLM and the actual data feed of the virtual environment. For instance, the comparator may calculate a “distance” between the output of the generative MLM and the actual data feed of the virtual environment. The distance, may comprise, for example, a cosine distance or cosine similarity (based on images, frames (e.g., sequence of images), or the like, or on other data vectors), a structural similarity index metric (SSIM), etc. It should be noted that in either of the foregoing examples, the output of the machine learning-based module may output a distance metric or another value that represents the likelihood that at least one action of the user representation is (or is not) a result of the controller device output(s). As such, step 260 may comprise obtaining a binary output indicative of a deviation (e.g., cheating) or a value/score that exceeds a threshold (and which is thus indicative of cheating).

In one example, step 260 may include detecting the deviation of the at least one action from the controller device output data and from the visual data feed via the at least one machine learning module. For instance, in one example, at optional step 230 the processing system may obtain a visual data feed from at least one camera directed at the gaming controller device. In such an example, the binary classifier may further take the visual data feed as input(s) (and may be so trained at optional step 210). In other words, the input data to the binary classifier may comprise: (1) output data of one or more controller devices, (2) the visual data feed, and (3) the data feed of the virtual environment. Similarly, a generative MLM may take as inputs (1) the output data of one or more controller devices and (2) the visual data feed, and may output data values representing a state of at least a portion of the virtual environment (or a sequence of states (e.g., frames) of at least a portion of the virtual environment) containing one or more predicted actions and/or an outcome of such predicted action(s). In addition, the generative MLM may be so trained via training data of the same types at optional step 210.

At step 270, the processing system generates an alert in response to the detecting of the deviation. In one example, step 270 may comprise transmitting the alert to server(s) hosting the virtual environment (e.g., the video game host server(s)). The alert may indicate the user/user representation for which cheating is detected, the confidence/likelihood score or the like, and so forth.

At optional step 280, the processing system may perform at least one remedial action in response to the alert. For instance, the remedial action may include warning the user via a message to be presented via a display of the user device or associated with the user device, and/or via an email, text message, or similar communication. In one example, the remedial action may alternatively or additionally comprise causing the user to forfeit a current round of a game, to forfeit recent game winnings, game finds, etc., blocking/banning an account of the user from the virtual environment (e.g., for a certain time period or indefinitely), and so forth. For instance, in one example, the processing system may comprise a gaming platform (e.g., one or more game servers/hosts). In one example, the remedial action may extend to all IP addresses and/or user device hardware identifiers known to be associated with the user, other accounts associated with the user, and so on. In one example, the remedial action may be dependent upon a confidence/likelihood score from the at least one machine learning module, a number of prior warnings/alerts, and so on.

Following step 270 or optional step 280, the method 200 proceeds to step 295. At step 295, the method 200 ends.

It should be noted that the method 200 may be expanded to include additional steps, or may be modified to replace steps with different steps, to combine steps, to omit steps, to perform steps in a different order, and so forth. For instance, in one example, the processing system may repeat one or more steps of the method 200, such as performing steps 220-260 on an ongoing basis until a deviation is detected, performing steps 210-270 or steps 220-260 for other users, and so forth. As noted above, in one example, confidence/likelihood scores (e.g., distance metrics) may be averaged over time, and the average compared to a threshold for alerting. Thus, in one example, steps of the method 200 may be repeated to aggregate outputs of the at least one machine learning module (e.g., at least until a threshold is exceeded and thus a deviation detected, or until a game ends, etc.). In one example, the method 200 may include training one or more detection models (e.g., MLMs) for detecting events (e.g., for use in optional step 250). In one example, the method 200 may further include gathering training data for training the model(s) at optional step 210 and/or for use in training the model(s) that may be deployed in connection with optional step 250.

In an alternative example, MLM(s) of the one or more machine learning modules may be trained with input data comprising (1) visual data feed data (e.g., of a camera directed at a controller device) and (2) a data feed of the virtual environment. In other words, an MLM may learn expected actions in the data feed (virtual actions) that correspond to physical actions of the user interacting with the controller device. For instance, in the event that the controller device output data is not directly available, an MLM may still monitor for correspondence between how a user physically interacts with a controller device and the resultant actions of the virtual representation of the user in the virtual environment. For example, step 260 may apply the visual data feed and the data feed of the virtual environment as inputs to such a machine learning module (and/or the MLM(s) thereof). Where the user is only mimicking control, the processing system may detect that the actions of the user representation do not match the physical interaction of the user with the controller device (and hence that a cheating mechanism appears to be involved). In various other examples, the method 200 may further include or may be modified to comprise aspects of any of the above-described examples in connection with FIG. 1, or as otherwise described in the present disclosure. Thus, these and other modifications are all contemplated within the scope of the present disclosure.

In addition, although not expressly specified above, one or more steps of the method 200 may include a storing, displaying and/or outputting step as required for a particular application. In other words, any data, records, fields, and/or intermediate results discussed in the method 200 can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method 200 can be combined, separated, and/or performed in a different order from that described above, without departing from the example embodiments of the present disclosure.

FIG. 3 depicts a high-level block diagram of a computing system 300 (e.g., a computing device or processing system) specifically programmed to perform the functions described herein. For example, any one or more components, devices, and/or systems illustrated in FIG. 1 or described in connection with FIG. 2, may be implemented as the computing system 300. As depicted in FIG. 3, the computing system 300 comprises a hardware processor element 302 (e.g., comprising one or more hardware processors, which may include one or more microprocessor(s), one or more central processing units (CPUs), and/or the like, where the hardware processor element 302 may also represent one example of a “processing system” as referred to herein), a memory 304, (e.g., random access memory (RAM), read only memory (ROM), a disk drive, an optical drive, a magnetic drive, and/or a Universal Serial Bus (USB) drive), a module 305 for detecting a deviation of at least one action of a virtual representation of a user within a virtual environment from controller device output data, and various input/output devices 306, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one hardware processor element 302 is shown, the computing system 300 may employ a plurality of hardware processor elements. Furthermore, although only one computing device is shown in FIG. 3, if the method(s) as discussed above is implemented in a distributed or parallel manner for a particular illustrative example, e.g., the steps of the above method(s) or the entire method(s) are implemented across multiple or parallel computing devices, then the computing system 300 of FIG. 3 may represent each of those multiple or parallel computing devices. Furthermore, one or more hardware processor elements (e.g., hardware processor element 302) can be utilized in supporting a virtualized or shared computing environment. The virtualized computing environment may support one or more virtual machines which may be configured to operate as computers, servers, or other computing devices. In such virtualized virtual machines, hardware components such as hardware processors and computer-readable storage devices may be virtualized or logically represented. The hardware processor element 302 can also be configured or programmed to cause other devices to perform one or more operations as discussed above. In other words, the hardware processor element 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer-readable instructions pertaining to the method(s) discussed above can be used to configure one or more hardware processor elements to perform the steps, functions and/or operations of the above disclosed method(s). In one example, instructions and data for the present module 305 for detecting a deviation of at least one action of a virtual representation of a user within a virtual environment from controller device output data (e.g., a software program comprising computer-executable instructions) can be loaded into memory 304 and executed by hardware processor element 302 to implement the steps, functions or operations as discussed above in connection with the example method(s). Furthermore, when a hardware processor element executes instructions to perform operations, this could include the hardware processor element performing the operations directly and/or facilitating, directing, or cooperating with one or more additional hardware devices or components (e.g., a co-processor and the like) to perform the operations.

The processor (e.g., hardware processor element 302) executing the computer-readable instructions relating to the above described method(s) can be perceived as a programmed processor or a specialized processor. As such, the present module 305 for detecting a deviation of at least one action of a virtual representation of a user within a virtual environment from controller device output data (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium may comprise a physical device, a hardware device, or a device that is discernible by the touch. More specifically, the computer-readable storage device or medium may comprise any physical devices that provide the ability to store information such as instructions and/or data to be accessed by a processor or a computing device such as a computer or an application server.

While various examples have been described above, it should be understood that they have been presented by way of example only, and not limitation. Thus, the breadth and scope of a preferred example should not be limited by any of the above-described examples, but should be defined only in accordance with the following claims and their equivalents.

What is claimed is:

1. A method comprising:
obtaining, by a processing system including at least one processor, controller device output data from a user device;
obtaining, by the processing system, a data feed of a region of a virtual environment associated with a virtual representation of a user of the user device within the virtual environment, the data feed including data identifying at least one action within the virtual environment of the virtual representation of the user;
detecting, by the processing system, a deviation of the at least one action from the controller device output data, wherein the detecting is via at least one machine learning module; and
generating, by the processing system, an alert in response to the detecting of the deviation.

2. The method of claim 1, wherein the at least one action comprises a movement of the virtual representation of the user within the virtual environment.

3. The method of claim 1, wherein the at least one action comprises an emitting of a virtual projectile within the virtual environment associated with the virtual representation of the user.

4. The method of claim 1, wherein the virtual representation of the user comprises an avatar.

5. The method of claim 1, wherein the virtual representation of the user comprises a virtual vehicle.

6. The method of claim 1, wherein the at least one machine learning module is for detecting a deviation between the controller device output data and the at least one action of the virtual representation of the user in the virtual environment.

7. The method of claim 1, wherein inputs to the at least one machine learning module comprise:
the controller device output data; and
at least a portion of the data feed of the region of a virtual environment.

8. The method of claim 7, wherein the at least one machine learning module comprises a binary classifier.

9. The method of claim 8, further comprising:
training the binary classifier to generate an output value indicative of whether the controller device output data matches the at least one action of the virtual representation of the user in the virtual environment.

10. The method of claim 6, wherein the at least one machine learning module comprises a generative machine learning model.

11. The method of claim 10, further comprising:
training the generative machine learning model to generate an expected action in the virtual environment that corresponds to the controller device output data.

12. The method of claim 10, wherein the at least one machine learning module further comprises a similarity function.

13. The method of claim 1, wherein the controller device output data is obtained via a kernel driver.

14. The method of claim 1, wherein the controller device output data is obtained via a hook-based monitoring.

15. The method of claim 1, wherein the controller device output data is obtained via a raw input application programming interface of an operating system of the user device.

16. The method of claim 1, wherein the controller device output data is from a gaming controller device.

17. The method of claim 16, further comprising:
obtaining a visual data feed from at least one camera directed at the gaming controller device.

18. The method of claim 17, wherein the detecting of the deviation of the at least one action from the controller device output data further comprises detecting the deviation of the at least one action from the controller device output data and from the visual data feed via the at least one machine learning module.

19. A non-transitory computer-readable medium storing instructions which, when executed by a processing system including at least one processor, cause the processing system to perform operations, the operations comprising:
obtaining controller device output data from a user device;
obtaining a data feed of a region of a virtual environment associated with a virtual representation of a user of the user device within the virtual environment, the data feed including data identifying at least one action within the virtual environment of the virtual representation of the user;
detecting a deviation of the at least one action from the controller device output data, wherein the detecting is via at least one machine learning module; and
generating an alert in response to the detecting of the deviation.

20. An apparatus comprising:
a processing system including at least one processor; and
a computer-readable medium storing instructions which, when executed by the processing system, cause the processing system to perform operations, the operations comprising:
obtaining controller device output data from a user device;
obtaining a data feed of a region of a virtual environment associated with a virtual representation of a user of the user device within the virtual environment, the data feed including data identifying at least one action within the virtual environment of the virtual representation of the user;
detecting a deviation of the at least one action from the controller device output data, wherein the detecting is via at least one machine learning module; and
generating an alert in response to the detecting of the deviation.
